(19) United States
(12) Patent Application Publication
(10) Pub. No.: US 2022/0140586 A1
(43) Pub. Date: May 5, 2022

(54) RECESSED COVER PLATE DEVICE

(71) Applicant: Richard Pike, Pasadena, CA (US)

(72) Inventor: Richard Pike, Pasadena, CA (US)

(21) Appl. No.: 17/517,942

(22) Filed: Nov. 3, 2021

Related U.S. Application Data
(60) Provisional application No. 63/108,922, filed on Nov. 3, 2020.

(51) Int. Cl. H02G 3/14; H02G 3/12

(52) U.S. Cl. CPC H02G 3/14; F24F 13/084; F24F 2221/26; H02G 3/12

(57) ABSTRACT

The present invention relates to a recessed cover plate device further comprised of a front plate that attaches to a base. In differing embodiments, the base and front plate can be applied around a junction box of a wall outlet, a junction box of a light switch, an exhaust fan or any other structure of the like, such as but not limited to, an air register. The front plate further sits flush with the surface of the drywall, providing a cleaner and more aesthetic appearance. In addition, the front plate and base may be manufactured from a plurality of materials, such that the front plate matches or contrasts with the color, texture, and/or appearance of any surrounding drywall or other wall, ceiling or floor surface.

### CROSS-REFERENCE TO RELATED APPLICATION

The present application claims priority to, and the benefit of, U.S. Provisional Application No. 63/108,922, which was filed on Nov. 3, 2020 and is incorporated herein by reference in its entirety.

### FIELD OF THE INVENTION

The present invention relates generally to the field of cover plates for junction boxes, wall outlets, light switches, exhaust fans, air registers, etc. More specifically, the present invention relates to a recessed cover plate device further comprised of a front plate that attaches to a base. In differing embodiments, the base and front plate can be applied around a junction box of a wall outlet, a junction box of a light switch, an exhaust fan, or any other structure of the like, such as but not limited to, an air register. The front plate further sits flush with the surface of drywall providing a cleaner and more aesthetic appearance. Accordingly, the present disclosure makes specific reference thereto. Nonetheless, it is to be appreciated that aspects of the present invention are also equally applicable to other like applications, devices and methods of manufacture.

### BACKGROUND

Wall outlets, light switches, air registers and exhaust fans are commonly found in every home. Said structures generally have a cover plate that conceals the gap between the structure and the drywall that surrounds the structure. However, these cover plates do not sit flush with the drywall, and instead sit in a raised position above the drywall. As a result of this position, the gap between the cover plate and the drywall can often be seen, which is unsightly and undesirable for homeowners. The perimeter of existing cover plates known in the art are further not secured to the surrounding drywall, and as a result may be bumped out of place or ripped off the wall entirely if the perimeter edge of the plate is caught. Further, most existing cover plates known in the art are manufactured from a smooth, white, plastic material. While this look is appealing for some individuals, it often does not match the surrounding wall color or wall material, and as a result limits the interior decorating capabilities of a homeowner.

Therefore, there exists a long-felt need in the art for an improved cover plate for wall outlets, light switches, air registers, exhaust fans, etc. There also exists a long-felt need in the art for a recessed cover plate device that sits flush with drywall, in contrast to sitting above drywall like existing cover plates known in the art. Further, there exists a long-felt need in the art for a recessed cover plate device that allows the device to blend in or contrast with the surrounding wall or room, per the design preferences of the user. Finally, there exists a long-felt need in the art for a recessed cover plate device that eliminates the visibility of the gap between the cover plate and the drywall.

The subject matter disclosed and claimed herein, in one embodiment thereof, comprises a recessed cover plate device. The device is comprised of a front plate that attaches to a base. In differing embodiments, the base and front plate can be applied around a junction box of a wall outlet, a junction box of a light switch, an exhaust fan, or any other structure of the like, such as but not limited to, an air register. The front plate further sits flush with the surface of the drywall providing a cleaner and more aesthetic appearance. In addition, the front plate and base may be manufactured from a plurality of material, such that the front plate matches or contrasts with the color, texture, and/or appearance of any surrounding drywall or other wall, ceiling, or floor surface.

In this manner, the recessed cover plate device of the present invention accomplishes all of the forgoing objectives and provides a cover plate that sits flush with drywall, therefore providing a more clean and desirable appearance than existing cover plates. Further, the device also conceals the gap between the cover plate and drywall. In addition, the device blends in or contrasts with the surrounding wall or room, per the design preferences of the user. Accordingly, the recessed cover plate device overcomes the limitations of existing cover plates known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a recessed cover plate device comprised of a cover plate assembly that is further comprised of a front plate that attaches to a base. In differing embodiments, the device can be applied around a junction box of a wall outlet, a junction box of a light switch, an exhaust fan, or any other structure of the like, such as but not limited to, an air register. The front plate may be manufactured from a plurality of materials, such that the front plate matches or contrasts with the color, texture, and/or appearance of any surrounding drywall or other wall, ceiling or floor surface. The front plate is further preferably square or rectangular in shape and is comprised of a primary continuous opening that allows the plate to be placed around a junction box and a wall outlet, a junction box and a light switch, an exhaust fan, an air register, or other similar structure that is found within a building or home. Further, the base may be manufactured from the same material as the front plate.

The base is preferably square or rectangular in shape, such that it can be placed around an electrical junction box that surrounds a wall outlet, an electrical junction box that surrounds a light switch, etc. The base also has a rectangular or square mounting frame. The mounting frame is preferably greater in size (i.e., width and length) than the base, such that the plate presses against the rear surface of the drywall. In this manner, the base is secured behind the drywall and cannot fall out or be easily pulled from the drywall. The base further has two sets of generally parallel sidewalls which are fixedly-connected to and extend away from the base and towards the top surface of the drywall. The top edge and interior surface of at least two of the sidewalls is further comprised of at least one tab with a continuous, threaded opening that receives a threaded screw to removably-secure the front plate to the base.

As noted, embodiments of the device can also be applied to an exhaust fan or an air register. In these embodiments, the mounting frame is extremely thin and is comprised of at least one continuous opening, such that at least one screw can be used to secure the mounting frame to a stud, a drywall surface or both. It is further preferred that the mounting frame is screwed to a stud and drywall is then applied over the base. Further, the sidewalls and front plate are identical in structure to previously described embodiments. Therefore, the front plate can be secured around the exhaust fan or an air register via at least one screw, wherein the front plate sits flush with the drywall surface.

Accordingly, the recessed cover plate device of the present invention is particularly advantageous as it sits flush with the drywall, providing a more clean and desirable appearance than existing cover plates, while also concealing the gap between the cover plate and drywall. Further, the device blends in or contrasts with the surrounding wall or room, per the design preferences of the user. In this manner, the recessed cover plate device overcomes the limitations of existing cover plates known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the recessed cover plate device of the present invention in accordance with the disclosed architecture;

FIG. 2 illustrates a side perspective cutaway view of one potential embodiment of the recessed cover plate device of the present invention in accordance with the disclosed architecture;

FIG. 3 illustrates a cross-sectional view of one potential embodiment of the recessed cover plate device of the present invention in accordance with the disclosed architecture;

FIG. 4 illustrates a perspective view of one potential embodiment of the recessed cover plate device of the present invention used with an exhaust fan in accordance with the disclosed architecture;

FIG. 5 illustrates a cross-sectional view of one potential embodiment of the recessed cover plate device of the present invention in accordance with the disclosed architecture; and

FIG. 6 illustrates a perspective view of one potential embodiment of the recessed cover plate device of the present invention used with an air register in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved cover plate for wall outlets, light switches, air registers, exhaust fans, etc. There also exists a long-felt need in the art for a recessed cover plate device that sits flush with drywall, in contrast to sitting above drywall, such as existing cover plates known in the art. Further, there exists a long-felt need in the art for a recessed cover plate device that allows the device to blend in or contrast with the surrounding wall or room, per the design preferences of the user. Finally, there exists a long-felt need in the art for a recessed cover plate device that eliminates the visibility of the gap between the cover plate and the drywall.

The present invention, in one exemplary embodiment, is comprised of a recessed cover plate device. The device is further comprised of a cover plate assembly that is further comprised of a front plate that attaches to a base. In differing embodiments, the device can be applied around a junction box of a wall outlet, a junction box of a light switch, an exhaust fan, or any other structure of the like, such as but not limited to, an air register. The front plate and base may be manufactured from a plurality of material, such that the front plate matches or contrasts with the color, texture, and/or appearance of any surrounding drywall or other wall, ceiling, or floor surface. The front plate is further preferably square or rectangular in shape and is comprised of a primary continuous opening that allows the plate to be placed around a junction box and a wall outlet, a junction box and a light switch, an exhaust fan, an air register, or other suitable structure that is known in the art and that is found within a building or home.

The base is preferably square or rectangular in shape, such that it can be placed around an electrical junction box that surrounds a wall outlet, an electrical junction box that surrounds a light switch, etc. Further, the base has a rectangular or square mounting frame that is preferably greater in size (i.e., width and length) than the base, such that the plate presses against the rear surface of the drywall. Therefore, the base is secured behind the drywall and cannot fall out or be easily pulled from the drywall. The base further has two sets of generally parallel sidewalls, which are fixedly-connected to and extend away from the base and towards the top surface of the drywall. The top edge and interior surface of at least two of the sidewalls is further comprised of at least one tab with a continuous, threaded opening that receives a threaded screw to removably-secure the front plate to the base.

Differing embodiments of the device can also be applied to an exhaust fan or an air register, wherein the mounting frame is extremely thin and is comprised of at least one continuous opening, such that at least one screw can be used to secure the mounting frame to a stud, a drywall surface or both. It is further preferred, that the mounting frame is screwed to a stud and drywall is then applied over the base. Further, the sidewalls and front plate are identical in structure to previously described embodiments. Therefore, the front plate can be secured around the exhaust fan or an air register via at least one screw, wherein the front plate sits flush with the drywall surface.

Accordingly, the recessed cover plate device of the present invention is particularly advantageous as it sits flush with drywall, providing a more clean and desirable appearance than existing cover plates, while also concealing the gap between the cover plate and the drywall. Further, the device blends in or contrasts with the surrounding wall or room, per the design preferences of the user. In this manner, the recessed cover plate device overcomes the limitations of existing cover plates known in the art.

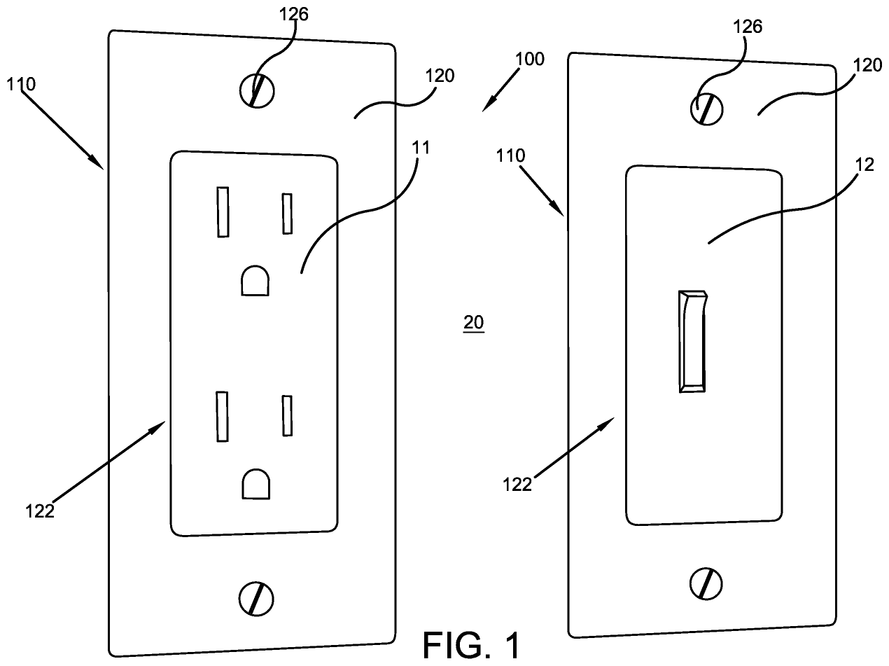

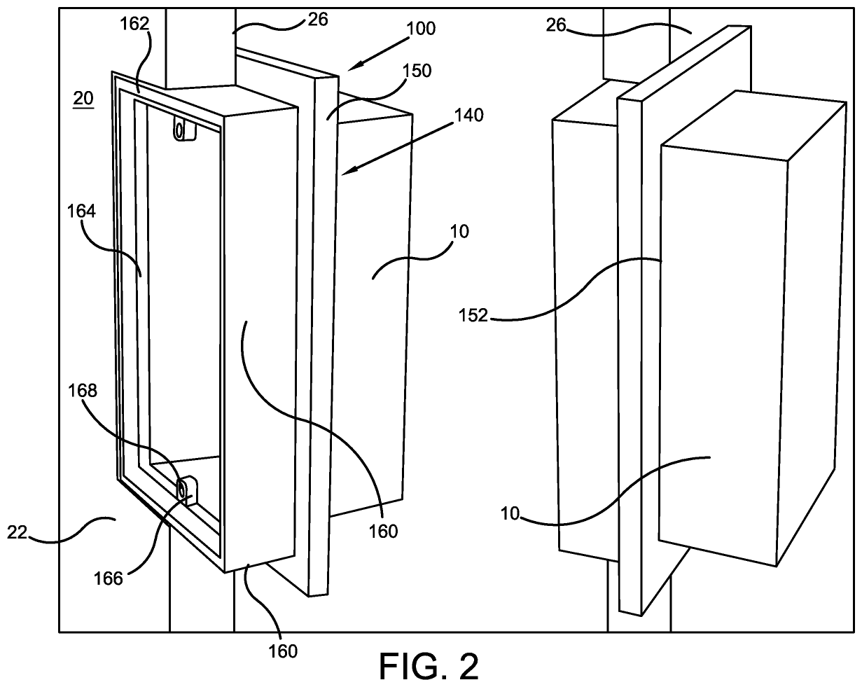

Referring initially to the drawings, FIG. 1 illustrates a front perspective view of one embodiment of the recessed cover plate device 100 of the present invention. The device 100 is comprised of a cover plate assembly 110 that is further comprised of a front plate 120 that attaches to a base 140 (shown in FIG. 2). The device 100 can be applied around a junction box 10 of a wall outlet 11, a junction box 10 of a light switch 12, an exhaust fan 30 or other suitable structure as is known in the art, such as but not limited to, an air register 50. In differing embodiments, the front plate 120 may be manufactured from a plurality of materials, such that the front plate 120 matches or contrasts with the color, texture and/or appearance of any surrounding drywall 20 or other wall, ceiling or floor surface, etc. The materials can include, but are not limited to, any wood material/type known in the art, an aluminum or other metal material, or a plastic material such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc., or any other suitable material as is known in the art.

Further, the front plate 120 is preferably square or rectangular in shape, but can be any other suitable shape as is known in the art. The front plate 120 also comprises a primary continuous opening 122, that allows the front plate 120 to be placed around a junction box 10 and a wall outlet 11, a junction box 10 and a light switch 12, an exhaust fan 30, an air register 50, etc., or any other suitable structure as is known in the art and found within a building or home. Further, the base 140 may be manufactured from the same materials as the front plate 120.

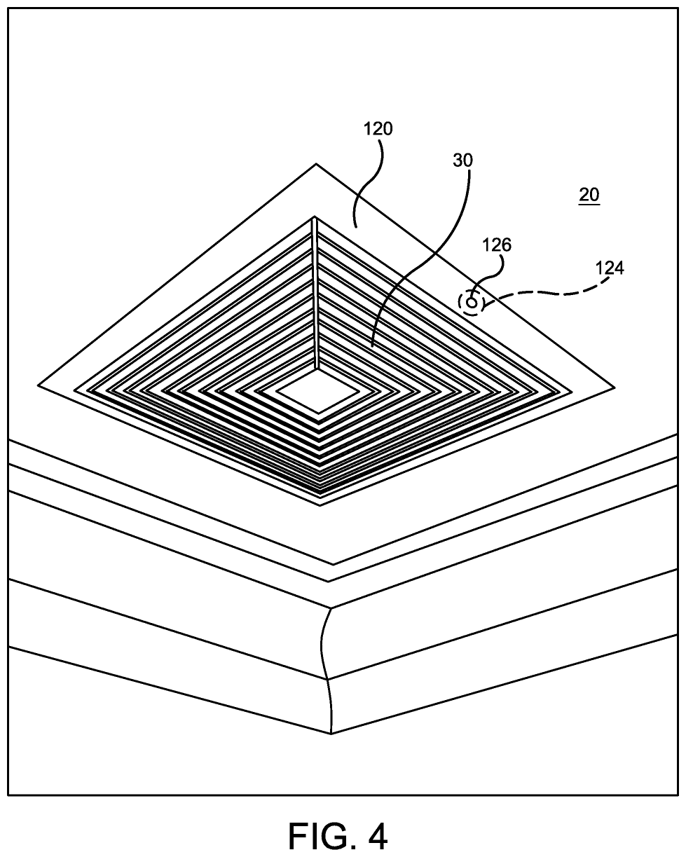

FIG. 2 illustrates a side perspective cutaway view of one embodiment of the recessed cover plate device 100 of the present invention. The base 140 is preferably square or rectangular in shape, such that it can be placed around an electrical junction box 10 that surrounds a wall outlet 11, an electrical junction box 10 that surrounds a light switch 12, etc. The base 140 is further comprised of a rectangular or square mounting frame 150 that is greater in size (i.e., width and length) than the base 140. In this manner, the mounting frame 150 presses against the rear surface 26 of the drywall 20, such that the base 140 is secured behind the drywall 20 and cannot fall out or be easily pulled from the drywall 20. Two sets of generally parallel sidewalls 160 are fixedly-connected to and extend away from the base 140 and towards the top surface 22 (i.e., outer visible surface) of the drywall 20. The top edge 162 and interior surface 164 of at least two of the sidewalls 160 is further comprised of at least one tab 166 with a continuous, threaded opening 168. In one embodiment, the continuous opening 168 can be non-threaded, as well. The threaded opening 168 of each tab 166 can further receive a threaded screw 126 (shown in FIG. 1), or other suitable fastener as is known in the art, that can be placed through at least two continuous openings 124 (shown in FIG. 4) of the front plate 120. In this manner, the front plate 120 can be removably-screwed to the base 140, when the device 100 is in an assembled position around a junction box 10 and wall outlet 11, a junction box 10 and a light switch 12, an exhaust fan 30 or other suitable structure, such as but not limited to, an air register 50. It should be appreciated that in the preferred embodiment, the openings 168 correspond in location to any existing openings on any portion of a junction box 10, wall outlet 11, exhaust fan 30, etc.

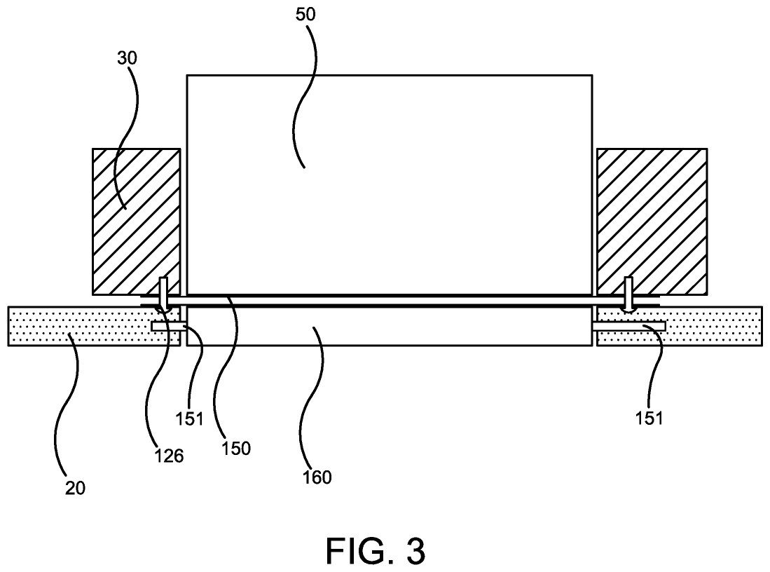

FIGS. 3-4 illustrate an embodiment of the recessed cover plate device 100 of the present invention applied to an exhaust fan 30. As stated supra, in the embodiment of the device 100 that is applied to an exhaust fan 30, the mounting frame 150 is extremely thin and is comprised of at least one continuous opening 152, such that at least one screw 126 can be used to secure the mounting frame 150 to a stud 40, a drywall 20 surface or both. However, in this embodiment it is preferred that the mounting frame 150 is screwed to a stud 40 and drywall 20 is then applied over the base 140. Further, the sidewalls 160 and front plate 120 are identical in structure to previously described embodiments (other than the size of the primary continuous opening 122). In this manner, the front plate 120 can be secured around the exhaust fan 30 via at least one screw 126. Further, the front plate 120 sits flush with the drywall surface 20. In this embodiment, it is further preferred that the frame 150 can be screwed into the rim/existing box of the exhaust fan 30 box. The frame 150 may also have at least one continuous opening 168 that corresponds in location to any existing openings on any portion of a junction box 10, wall outlet 11, exhaust fan 30, etc. In this embodiment, a portion of the mounting frame 150 (and or at least one sidewall 160) has at least one flange 151 (e.g. has at least one flanged surface) such that after the frame 150 has been installed, it can be plastered over. In this manner, the flanged construction prevents cracking between the frame 150 and drywall 20.

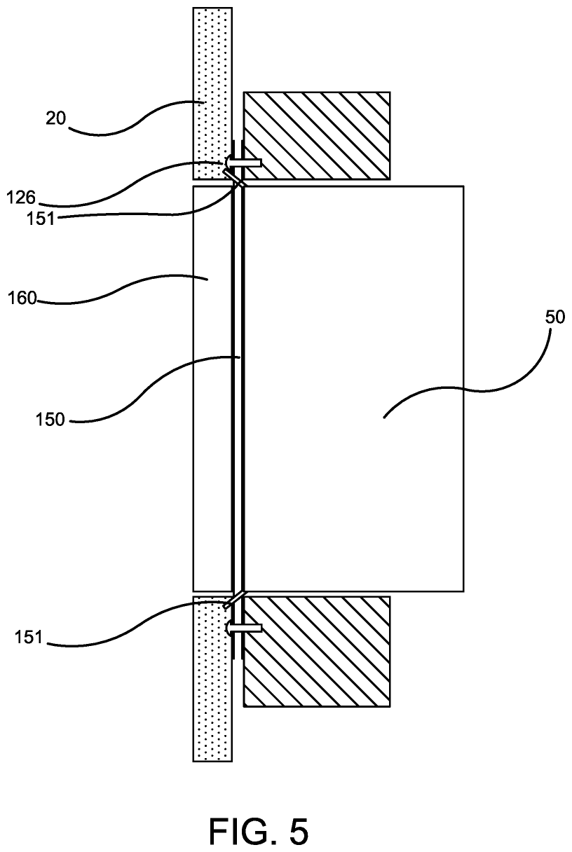

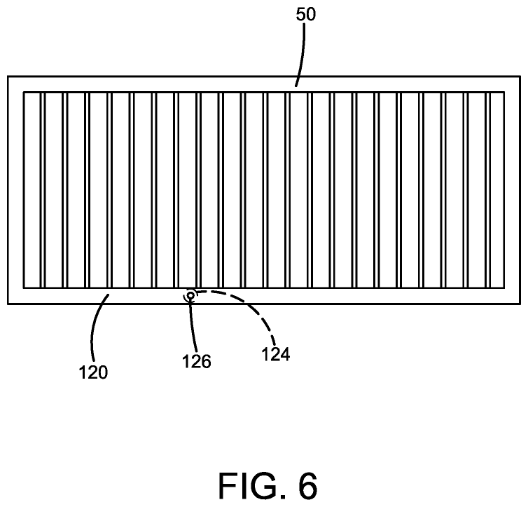

FIGS. 5-6 illustrate an embodiment of the recessed cover plate device 100 of the present invention applied to an air register 50. Like the embodiment of the device 100 that is applied to an exhaust fan 30, the mounting frame 150 is extremely thin and is comprised of at least one continuous opening 152, such that at least one screw 126 can be used to secure the mounting frame 150 to a stud 40, a drywall 20 surface or both. However, in this embodiment it is preferred that the mounting frame 150 is screwed to a stud 40 and drywall 20 is then applied over the base 140. Further, the sidewalls 160 and front plate 120 are identical in structure to previously described embodiments (other than the size of the primary continuous opening 122). In this manner, the front plate 120 can be secured around the air register 50 via at least one screw 126 threaded through the continuous opening 124. Once secured, the front plate 120 sits flush with the drywall surface 20. In this embodiment, it is further preferred that the frame 150 can be screwed into the rim/existing box of the air register 50. The frame 150 may also have at least one continuous opening 168 that corresponds in location to any existing openings on any portion of a junction box 10, wall outlet 11, exhaust fan 30, etc. Further, the frame 150 may be secured to existing ductwork within a wall or ceiling. In this embodiment, a portion of the mounting frame 150 (and or at least one sidewall 160) has at least one flange 151 (e.g. has at least one flanged surface) such that after the frame 150 has been installed, it can be plastered over. In this manner, the flanged construction prevents cracking between the frame 150 and drywall 20.

It should further be appreciated that in differing embodiments, the front plate 120 may be attached to the base 140 via a plurality of alternative (non-screw) fastening methods. Said methods may include, but are not limited to, an adhesive, magnetic, hook and loop, tongue and groove, male to female connection, etc., or any other suitable fastening means as is known in the art. In addition, it should be noted that any embodiment of the device 100 is configured such that the front plate 120 is flush with any drywall surface 20 the device 100 may be placed within. Finally, the screw 126 may have the same color, texture, and/or appearance as the front plate 120 and/or base 140.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “recessed cover plate device” and “device” are interchangeable and refer to the recessed cover plate device 100 of the present invention.

Notwithstanding the forgoing, the recessed cover plate device 100 of the present invention and its various components can be of any suitable size and configuration as is known in the art without affecting the overall concept of the invention, provided that they accomplish the above-stated objectives. One of ordinary skill in the art will appreciate that the size, configuration and material of the recessed cover plate device 100 as shown in FIGS. 1-6 is for illustrative purposes only, and that many other sizes and shapes of the recessed cover plate device 100 are well within the scope of the present disclosure. Although the dimensions of the recessed cover plate device 100 are important design parameters for user convenience, the recessed cover plate device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A recessed cover plate device comprising:
a front plate comprised of a primary continuous opening and at least two continuous openings that receive at least one screw; and
a base comprised of a mounting frame, a continuous opening, a first set of generally parallel sidewalls that extend away from the mounting frame towards a top surface of a drywall surface, a second set of generally parallel sidewalls perpendicular to the first set of generally parallel sidewalls, that extend away from the mounting frame towards a top surface of a drywall surface, and at least two tabs further comprised of at least one threaded continuous opening.

2. The recessed cover plate device of claim 1, wherein the recessed cover plate device is sized and configured to be applied to a select one of a junction box of a wall outlet, a junction box of a light switch, an exhaust fan or an air register.

3. The recessed cover plate device of claim 1, wherein the front plate and the base match with a color, a texture and an appearance of a surrounding drywall surface.

4. The recessed cover plate device of claim 1, wherein the front plate sits flush with a surface of drywall when the front plate is attached to the base via the at least one screw that engages the at least one threaded continuous opening.

5. A recessed cover plate device that can be applied to an exhaust fan or an air register, the recessed cover plate device comprising:
a front plate comprised of a primary continuous opening and at least two continuous openings that receive at least one screw; and
a base comprised of a mounting frame, a continuous opening, a first set of generally parallel sidewalls that extend away from the mounting frame towards a top surface of a drywall surface, a second set of generally parallel sidewalls perpendicular to the first set of generally parallel sidewalls, that extend away from the mounting frame towards a top surface of a drywall surface, and at least two tabs comprised of at least one threaded continuous opening that can receive the at least one screw to allow the front plate to attach to the base.

6. The recessed cover plate device of claim 5, wherein the front plate and the base match with a color, a texture and an appearance of a surrounding drywall.

7. The recessed cover plate device of claim 5, wherein the mounting frame is further comprised of at least one continuous opening that receives at least one screw.

8. The recessed cover plate device of claim 7, wherein the at least one screw can be screwed to a stud or a drywall surface to secure the mounting frame to the stud or the drywall surface.

9. The recessed cover plate device of claim 5, wherein the front plate sits flush with a surface of drywall when the front plate is attached to the base via the at least one screw that engages the at least one threaded continuous opening.

10. A recessed cover plate device that can be applied to a junction box of a wall outlet and a junction box of a light switch, the recessed cover plate device comprising:
a front plate comprised of a primary continuous opening and at least two continuous openings that receive at least one screw;
a base comprised of a mounting frame, a continuous opening, a first set of generally parallel sidewalls that extend away from the mounting frame towards a top surface of a drywall surface, a second set of generally parallel sidewalls perpendicular to the first set of generally parallel sidewalls, that extend away from the mounting frame towards a top surface of a drywall surface, and at least two tabs further comprised of at least one threaded continuous opening that can receive the at least one screw to allow the front plate to attach to the base; and
wherein the at least one screw can be screwed to a stud or a drywall surface to secure the mounting frame to the stud or the drywall surface.

11. The recessed cover plate device of claim 10, wherein the front plate and the base match with a color, a texture and an appearance of a surrounding drywall.

12. The recessed cover plate device of claim 10, wherein the front plate sits flush with a surface of drywall when the front plate is attached to the base.

13. The recessed cover plate device of claim 10, wherein the continuous opening of the base allows the base to be placed around a junction box.

14. The recessed cover plate device of claim 10, wherein the mounting frame is greater in size than the base.

15. The recessed cover plate device of claim 14, wherein the mounting frame presses against a rear surface of a drywall surface, such that the base is secured behind the drywall surface and cannot fall from the drywall surface.

16. The recessed cover plate device of claim 10, wherein the at least two tabs are located on an interior surface and a top edge of the base.

17. The recessed cover plate device of claim 10, wherein the at least one screw and the at least two tabs allow the front plate to be screwed to the base.

18. The recessed cover plate device of claim 10, wherein the recessed cover plate device eliminates the visible gap between the front plate and a drywall surface.

19. The recessed cover plate device of claim 17, wherein the at least one screw has a same color, a same texture, and a same appearance as the front plate and the base.

20. The recessed cover plate device of claim 10, wherein the front plate and the base are manufactured from a wood, a metal, or a plastic material.
